(19) United States
(12) Patent Application Publication
(10) Pub. No.: US 2015/0198346 A1
(43) Pub. Date: Jul. 16, 2015

(54) HVAC CONTROL SYSTEM AND METHOD OF CONTROLLING AN HVAC SYSTEM

(71) Applicant: Girish Vedpathak, Algonquin, IL (US)

(72) Inventor: Girish Vedpathak, Algonquin, IL (US)

(21) Appl. No.: 14/598,193

(22) Filed: Jan. 15, 2015

Related U.S. Application Data
(60) Provisional application No. 61/927,689, filed on Jan. 15, 2014.

(51) Int. Cl. F24F 11/00; G05B 15/02

(52) U.S. Cl. CPC F24F 11/006; G05B 15/02

(57) ABSTRACT

A control system is configured to improve the efficiency of the heating and/or cooling equipment, and to aid in cutting costs associated with the running of the heating and/or cooling equipment. That is, to save the user on utility costs, while maintaining comfort within the space that is controlled. It is another objective to facilitate advanced programming of the system as well as scheduling conflict resolution. The control system generally comprises a control unit 12 and a remote controller 14 (which may comprise a smartphone, a computer or the like).

### CROSS-REFERENCE TO RELATED APPLICATION

This application claims priority from U.S. Provisional Patent Application Ser. No. 61/927,689 filed Jan. 15, 2014, entitled “HVAC Control System And Method Of Controlling An HVAC System”, the entire disclosure of which is hereby incorporated by reference in its entirety.

### BACKGROUND OF THE DISCLOSURE

1. Field of the Disclosure

The disclosure relates in general to a control system, and more particularly, to a HVAC control system which provides savings to the user by meeting the user's climate control needs while maximizing efficiency. It will be understood that HVAC refers to climate control systems generally and interchangeably. It will be understood that HVAC and/or climate control system may include any number of units and types of systems that alter temperature or other conditions in a given space (i.e., air conditioner, heater, heat pump, electric floor heat, swamp cooler, evaporator, among others). The use of HVAC and/or climate control system is not to be deemed limiting to any particular type of system, or mode of operation of system, or a system that can both heat and cool.

2. Background Art

The use of different controllers for HVAC systems is known in the art. For example, early controllers had merely an on position or an off position. As models became more sophisticated, the systems could be controlled thermostatically (often through a mercury type thermostat switch).

Over time, further developments led to programmable thermostats and controllers. Such controllers allowed for cycling off and on based on temperature, and also allowed for different temperature settings based on the time of day. Many of these programmable thermostats provided displays and data entry buttons to facilitate the programming. Problematically, the programmable thermostats were often, and continue to be, difficult to set and provide very rigid timing and scheduling parameters.

Other thermostats that are both programmable and have some artificial intelligence (i.e., learning thermostats) have been developed. One example of which is the thermostat sold under the Nest trade name. Such a thermostat, it is disclosed, includes sensors that can determine certain patterns of the user, and can adjust performance accordingly.

Despite these advances, there remains a need for a controller for an HVAC system that can easily be programmed and reprogrammed. Additionally, there is a need for a controller for an HVAC system that provides additional savings over conventional thermostats and also over programmable and so-called advanced controllers. Furthermore, there is a need for a controller that can demonstrate savings that can be achieved through changes that are made to the operating parameters.

### SUMMARY OF THE INVENTION

The disclosure is directed to a thermostat that includes a first communication connection, a second communication connection, a user communication connection, one or more processor units and one or more computer readable media. The first communication connection is in communication with at least one condition sensor. The second communication connection is in communication with a climate control system. The user communication connection is configured to receive an input from a user requesting a change in operating parameters of the thermostat. The one or more processor units is in communication with the first and second communication connections as well as with the user communication connection. The one or more computer-readable media comprising computer-executable instructions which, when executed by the one or more processing units, cause the thermostat to perform steps comprising: receiving a communication from the user communication connection to reduce a cost of operating the climate control system; receiving communication through the first communication connection pertaining to the at least one condition sensor; determining at least one operating parameter of the climate control system to be changed to reduce the cost of operating the climate control system; and communicating through the second communication connection with the climate control system to alter the at least one operating parameter of the climate control system to achieve a reduction in the cost of operating the climate control system.

In some configurations, the one or more computer-readable media further includes computer-executable instructions which when executed by the one or more processing units cause the thermostat to perform steps comprising: receiving through the user communication connection at least a lower and an upper threshold of the at least one operating parameter of the climate control system. This occurs wherein the step of determining an operating parameter of the climate control system to be changed further includes the step of confirming that the at least one operating parameter to be changed results in the at least one operating parameter being between the lower and upper threshold of the operating parameter.

In some configurations, the at least one operating parameter comprises at least one of temperature and humidity.

In some configurations, the step of receiving further includes the receiving of a lower and an upper threshold of the at least one operating parameter pertaining to a comfort range, and a lower and an upper threshold of the at least one operating parameter pertaining to a comfort margin.

In some configurations, the at least one operating parameter includes a plurality of operating parameters, with each of the operating parameters including a comfort range and a comfort margin. The step of determining an operating parameter of the climate control system to be changed further includes the step of determining which of the plurality of operating parameters is to be changed to maintain the user closer to or within the comfort range.

In some configurations, the thermostat further includes data pertaining to operating cost of the climate control system. The one or more computer-readable media further includes computer-executable instructions which when executed by the one or more processing units cause the thermostat to perform steps comprising: determining the change in operating cost of the climate control system based upon the change in the at least one operating parameter; and providing to the user the determined change in operating cost.

In some configurations, the user communication connection is configured to receive a single communication in the form of a request to save from a user.

In another aspect of the disclosure, the disclosure is directed to a thermostat comprising a first communication connection, a second communication connection, a user communication connection, one or more processor units, and one or more computer-readable media. The first communication connection is in communication with at least one condition sensor. The second communication connection is in communication with a climate control system. The user communication connection is configured to receive an input from a user as to a timing schedule for the operation of the climate control system. The one or more processor unit(s) is in communication with the first and second communication connections as well as the user communication connection. The one or more computer-readable media comprising computer-executable instructions which when executed by the one or more processing units cause the thermostat to perform steps comprising: receiving a timing schedule from a user; determining if the timing schedule from the user conflicts with an existing timing schedule; and performing a conflict resolution to determine an operating timing schedule based on the timing schedule from the user and the existing timing schedule.

In some configurations, the step of performing a conflict resolution further includes the step of utilizing the new timing schedule in place of the existing timing schedule where an overlap exists, and utilizing the existing timing schedule before and after the new timing schedule.

In some configurations, the step of performing a conflict resolution to determine an operating timing schedule based upon the timing schedule from the user and the existing timing schedule further is achieved without further input from a user, or requiring a change in the timing schedule submitted by the user prior to operation.

In another aspect of the disclosure, the disclosure is directed to a method of operating a thermostat comprising the steps of: receiving a communication from a user communication connection to reduce a cost of operating a climate control system; receiving communication through a first communication connection pertaining to the at least one condition sensor; determining at least one operating parameter of the climate control system to be changed to reduce the cost of operating the climate control system; communicating through a second communication connection with the climate control system to alter the at least one operating parameter of the climate control system to achieve a reduction in the cost of operating the climate control system; receiving a timing schedule from a user; determining if the timing schedule from the user conflicts with an existing timing schedule; and performing a conflict resolution to determine an operating timing schedule based on the timing schedule from the user and the existing timing schedule.

In some configurations, the method of operating a thermostat further comprises the steps of: receiving through the user communication connection at least a lower and an upper threshold of the at least one operating parameter of the climate control system. The step of determining an operating parameter of the climate control system to be changed further includes the step of confirming that the at least one operating parameter to be changed results in the at least one operating parameter being between the lower and upper threshold of the operating parameter.

In some configurations, the at least one operating parameter comprises at least one of temperature and humidity.

In some configurations, the step of receiving further includes the receiving of a lower and an upper threshold of the at least one operating parameter pertaining to a comfort range, and a lower and an upper threshold of the at least one operating parameter pertaining to a comfort margin.

In some configurations, the at least one operating parameter includes a plurality of operating parameters, with each of the operating parameters including a comfort range and a comfort margin. The step of determining an operating parameter of the climate control system to be changed further includes the step of determining which of the plurality of operating parameters to be changed to maintain the user closer to or within the comfort range.

In some configurations, the thermostat further includes data pertaining to operating cost of the climate control system. The method further comprises the steps of: determining the change in operating cost of the climate control system based upon the change in the at least one operating parameter; and providing to the user the determined change in operating cost.

In some configurations, the thermostat is configured to receive a single communication in the form of a request to save from a user.

In some configurations, the step of performing a conflict resolution further includes the step of utilizing the new timing schedule in place of the existing timing schedule where an overlap exists, and utilizing the existing timing schedule before and after the new timing schedule.

In some configurations, the step of performing a conflict resolution to determine an operating timing schedule based upon the timing schedule from the user and the existing timing schedule further is achieved without further input from a user, or requiring a change in the timing schedule submitted by the user prior to operation.

### BRIEF DESCRIPTION OF THE DRAWINGS

The disclosure will now be described with reference to the drawings wherein:

FIG. 1 of the drawings is a schematic representation of a building having the system of the present disclosure;

FIG. 2 of the drawings is a schematic representation of a computing device which may be utilized in association with the present disclosure;

FIG. 3 of the drawings is a schematic representation of the schedule processing block diagram of the present disclosure;

FIG. 4 of the drawings is a flow chart diagram of the save system functionality of the present disclosure;

FIG. 5 of the drawings is a flow chart of the scheduling system of the present disclosure; and

FIG. 6 of the drawings is a graphical representation of the different conflicts in programming that may occur with the system.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

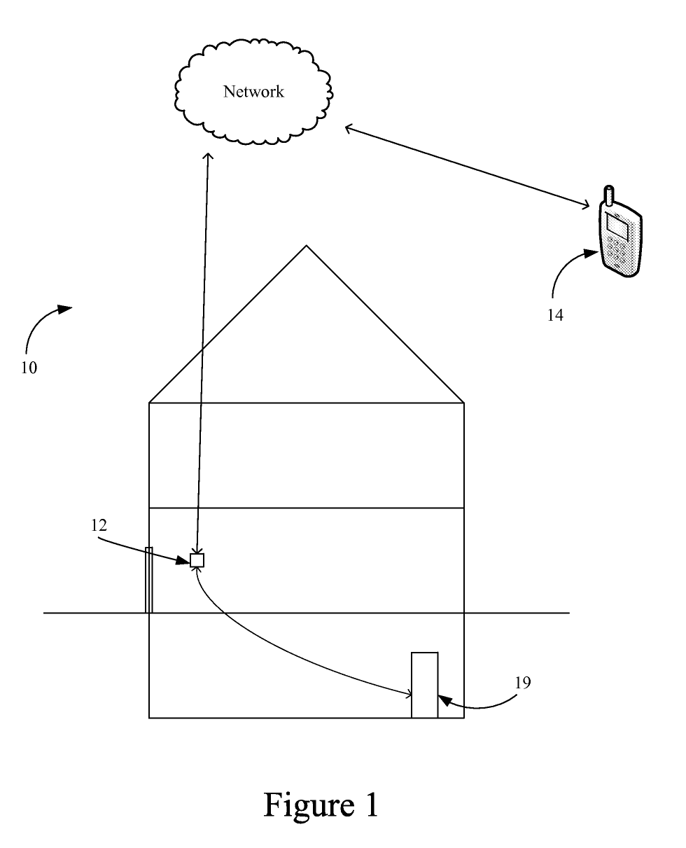

Referring now to the drawings and in particular to FIG. 1, the HVAC control system (also referred to commonly as a thermostat) is shown generally at 10. The control system can be coupled to heating and/or cooling equipment 19, such as an air conditioner, a heat pump, a furnace and the like to control the same within a space, such as an office, home, factory or the like. As set forth above, it will be understood that the control system is not limited to use in association with any particular type of heating or cooling equipment, nor is the control system limited to use in association with any particular type of building structure, or zone to be controlled. It will be understood that the control system is referred to herein, interchangeably, as a thermostat, with the understanding that the term thermostat includes a control unit that can control various conditions of a climate control system, including but not limited to temperature.

The control system is configured to improve the efficiency of the heating and/or cooling equipment (i.e., the climate control system), and to aid in cutting costs associated with the running of the heating and/or cooling equipment. That is, an objective to achieve is to save the user on utility costs, while maintaining comfort within the space that is controlled. It is another objective to facilitate programming of the system. The control system generally comprises a control unit 12 and a remote controller 14 (which may comprise a smartphone, a computer or the like).

The control unit 12 as well as the remote controller 14 may each comprise computing devices that can communicate with each other. It will be understood that although not required, aspects of the descriptions below will be provided in the general context of computer-executable instructions, such as program modules, being executed by a computing device, namely the control unit or the remote controller, along with other remote computing devices through outside communication. More specifically, aspects of the description below will reference acts, methods and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to a specialized security system control module (which may be highly proprietary), a conventional server computing racks or conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments linked through a communications network. In a distributed computing environment, program modules may be located in both local and remote memory storage devices.

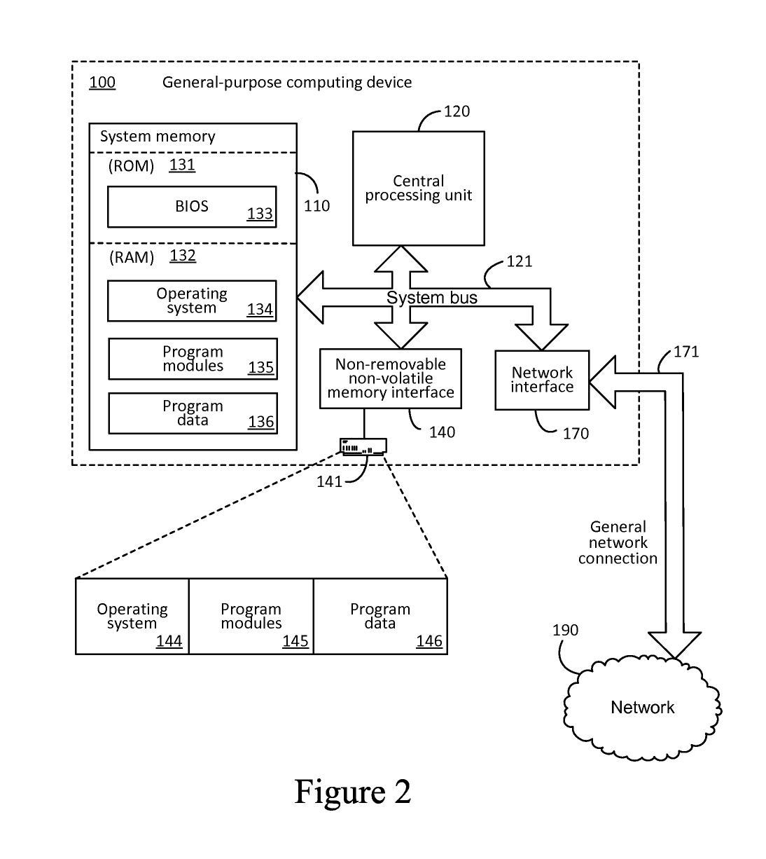

With reference to FIG. 2, an exemplary general-purpose computing device is illustrated in the form of the exemplary general-purpose computing device 100. The general-purpose computing device 100 may be of the type utilized for the control unit and the remote controller as well as the other computing devices with which the units may communicate through various outside communication methods. As such, it will be described with the understanding that variations can be made thereto. The exemplary general-purpose computing device 100 can include, but is not limited to, one or more central processing units (CPUs) 120, a system memory 110 and a system bus 121 that couples various system components including the system memory to the processing unit 120. The system bus 121 may be any of several types of bus structures including a memory bus or memory controller, a peripheral bus, and a local bus using any of a variety of bus architectures. Depending on the specific physical implementation, one or more of the CPUs 120, the system memory 110 and other components of the general-purpose computing device 100 can be physically co-located, such as on a single chip. In such a case, some or all of the system bus 121 can be nothing more than communicational pathways within a single chip structure and its illustration in FIG. 2 can be nothing more than notational convenience for the purpose of illustration.

The general-purpose computing device 100 also typically includes computer readable media, which can include any available media that can be accessed by computing device 100. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the general-purpose computing device 100. Computer storage media does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

When using communication media, the general-purpose computing device 100 may operate in a networked environment via logical connections to one or more remote computers. The logical connection depicted in FIG. 2 is a general network connection 171 to the network 190, which can be a local area network (LAN), a wide area network (WAN) such as the Internet, or other networks. The computing device 100 is connected to the general network connection 171 through a network interface or adapter 170 that is, in turn, connected to the system bus 121. In a networked environment, program modules depicted relative to the general-purpose computing device 100, or portions or peripherals thereof, may be stored in the memory of one or more other computing devices that are communicatively coupled to the general-purpose computing device 100 through the general network connection 171. It will be appreciated that the network connections shown are exemplary and other means of establishing a communications link between computing devices may be used.

The general-purpose computing device 100 may also include other removable/non-removable, volatile/nonvolatile computer storage media. By way of example only, FIG. 2 illustrates a hard disk drive 141 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140.

The drives and their associated computer storage media discussed above and illustrated in FIG. 2, provide storage of computer readable instructions, data structures, program modules and other data for the general-purpose computing device 100. In FIG. 2, for example, hard disk drive 141 is illustrated as storing operating system 144, other program modules 145, and program data 146. Note that these components can either be the same as or different from operating system 134, other program modules 135 and program data 136. Operating system 144, other program modules 145 and program data 146 are given different numbers here to illustrate that, at a minimum, they are different copies.

The control unit 12 is shown as comprising a housing which includes a furnace electrical coupling, the computing device described above having communication capabilities to communicate with a remote controller. The computing device may have an integrated display, and may also have a current temperature gauge or display. The electrical coupling may comprise a plurality of electrical leads, with the understanding that various systems will include different leads some or all of which can be coupled to the electrical coupling. It will be understood that the control unit is configured to be coupled to any number of different devices having different control wiring. The control unit has a number of different input so as to be compatible with, preferably, most of the different HVAC equipment on the market.

Additionally, the housing may include a lighting system which provides a colored halo around the device, or a soft glow around the device to indicate a current condition. Such a condition may include heating, cooling, furnace (or other device) running, or system off. Of course, there is no limit to the different conditions that can be identified through such a halo lighting.

The control unit 12 and the remote controller are configured so as to be in communication with each other. Most preferably, the two can communicate wirelessly. In one embodiment, the control unit 12 is part of a wireless or wired network that is linked to an outside network (or an internal network). Similarly, the remote controller 14 is similarly coupled to such a network. Thus, the two devices are capable of communicating over the web with each other. In other embodiments, other communication protocols may be utilized, including, but not limited to Bluetooth, cellular communication, RF communication and the like. In the embodiment contemplated the control unit comprises a wireless communication to a router or the like, and the remote controller comprises a smartphone having software thereon, which smartphone can be coupled to transmit data by way of cellular communication or WIFI communication.

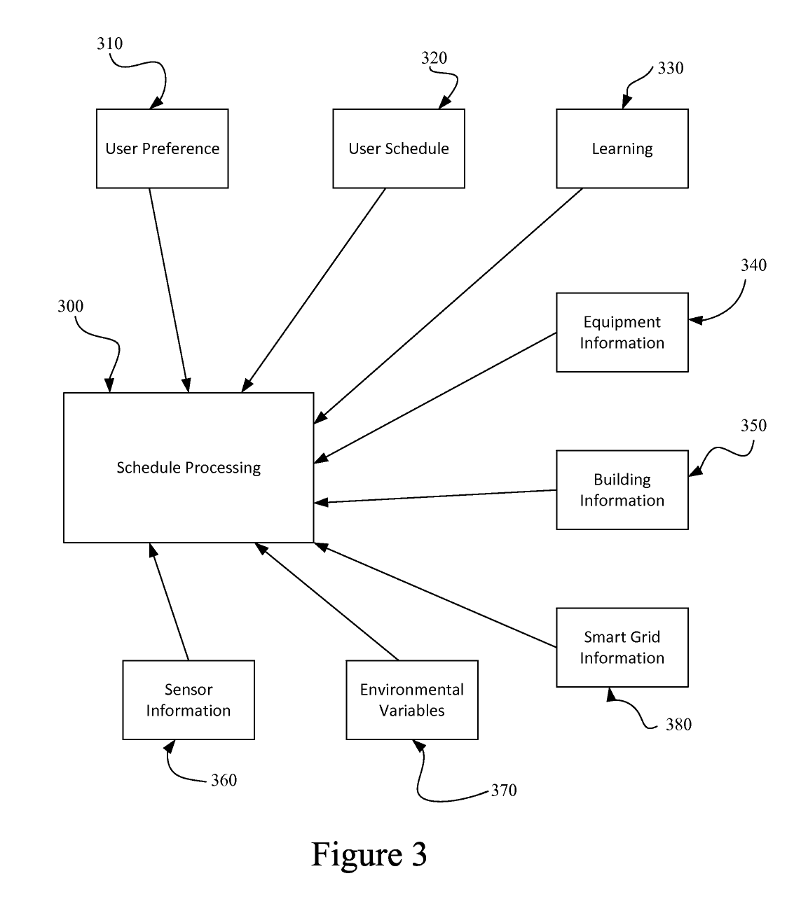

To operate the system, it is necessary for the system to know several variables (also known as operating parameters). Of course, it is not necessary to know each one of the variables, but the more variables that are known or provided to the system, the more versatile and robust the system operation. In particular, and with reference to FIG. 3, the schedule processing engine is shown schematically. The schedule processing engine 300 takes into account a number of different sets of variables 310-380. In particular, at 310, the user preferences are provided. These settings include the preferred temperature settings and controls. Additionally, the user provides the comfort zone settings (that is, a temperature range around the ideal temperature within which the user is comfortable). The user further provides the comfort margin setting, which comprises a range of temperature (or other parameter) within which the user is willing to be in order to cut costs. For example, the ideal temperature for the user may be 70 degrees, but the user has a two degree comfort range in either direction, and a five degree comfort margin on either side of the two degree comfort range. Thus, the system knows that to save money, the user is willing to vary the temperature a couple degrees, and when real savings are desired, that range can be expanded another five degrees.

At 320, the user provides a schedule to the system. The system can be told to be in an on, off or save condition, reoccurring schedules and/or non-reoccurring schedules can be provided to the system. Thus, the system knows the desired parameters for running at different times throughout the day, and on different days. It will be understood that even in the most simple configuration, generally a desired temperature is provided.

At 330, the system can learn certain variables. That is, the system can learn through changes to the set points, and the user that is making the set point changes, parameters of the system that are desired when a particular user is in the home. From there, trends can be established. Additionally, the rates of change (i.e., heat loss or heat gain) can be calculated based on the different conditions.

At 340, the HVAC equipment information is provided. Such information may include the manufacturer, the model number, the serial number, the installation year, certain pressure, flow temperature loss information for various vents and the like. It will be understood that such information may provide the system with information such as the output of the system, the efficient running points of the equipment and the like.

At 350, the information pertaining to the building is provided. For example, the type of structure material, the living space square footage and configuration, the year of the building, the ceiling height, among other parameters may be provided to the system. It will be understood that the system may be robust so as to receive building plans in certain formats, whereas in other configurations, the system may receive several discrete pieces of information regarding the building.

At 360, the system may receive information from a plurality of different sensors. These may include both local sensors within the building, as well as sensors outside of the building. For example, in addition to indoor, outdoor temperature and humidity data, data pertaining to the temperature in certain rooms for comparison (i.e., the basement versus an upper floor, versus an attic, for example) can be provided. In other embodiments, a gradient across the levels of the home can be provided, along with humidity readings and the like.

At 370, environmental variables can be provided, such as the inside and outside building variables, and the rate of change over time of the different parameters. In addition, data can be provided based on the location, including, current weather, and average weather (temperature, humidity, sunrise, sunset, among others).

At 380, smart grid information can be provided. Such information includes current pricing schedules so that the system understands the different rates that apply and the timing of the different rates. In addition, the system can also be provided with usage details for the home, that is, the current load and average loads required by the home at different periods of time.

All of these inputs provide the system with variables and information to assist the system to achieve the desired temperature setting within the home. As set forth above, it is not necessary to provide each and every one of the details, but the more details that are provided, the more savings that the system can provide to the user.

In a first mode of operation, the system is configured to run at a desired ideal temperature, within a comfort zone and within a comfort margin. Typically, in a regular mode (non-saving mode) the system operates within the comfort zone or seeks the desired ideal temperature. Of course, accommodation can be made based on the different variables (i.e., run at different times based on rate differences, and the like).

In a second mode, a save button is provided to the user on the remote controller. The desire is to instantly save the user money each time the button is depressed. That is, the system will make some type of change to lessen cost. In addition, where rate information is known for the utility and other usage is known, the cost savings can be computed and transmitted to the user so that the user can have a virtually instant (or close to instant) understanding of the savings.

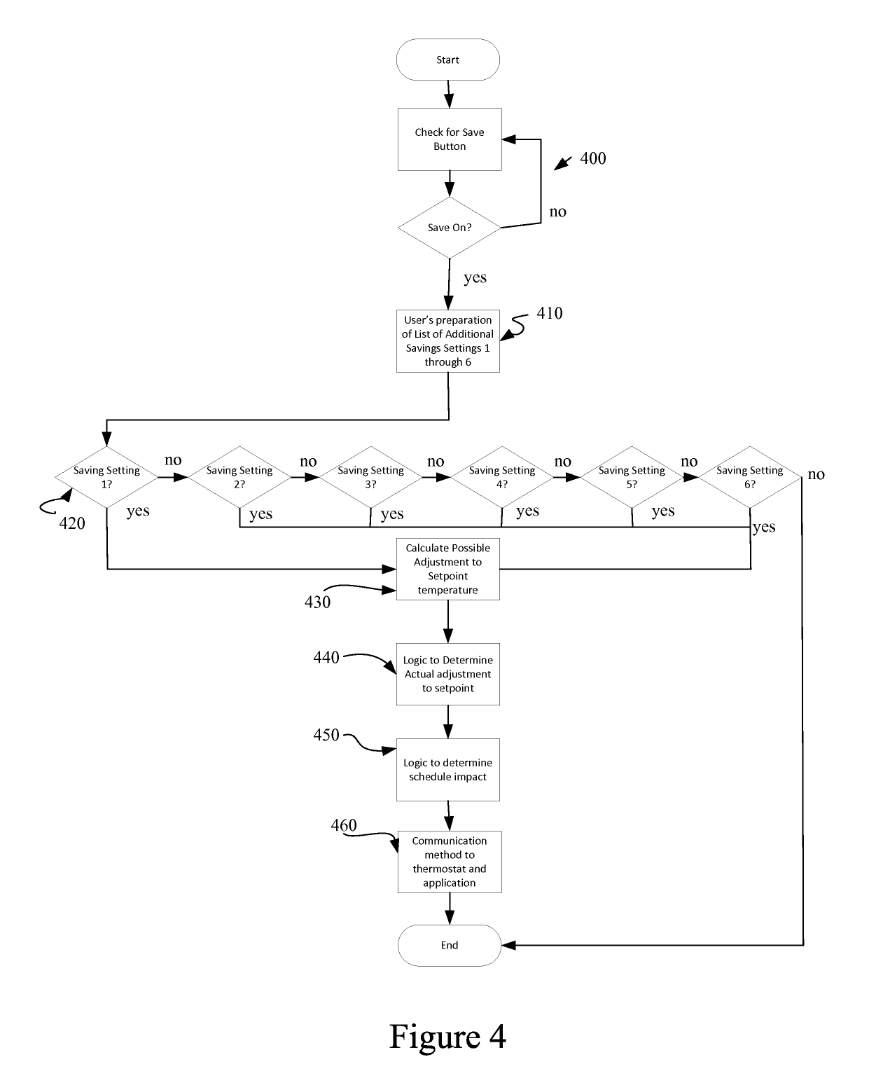

The operation of such a save feature is shown in FIG. 4. At the outset, the user is provided with a number of different options. Once the user provides the comfort margin settings, the user is prompted to provide input on different manners of achieving a cost savings, while remaining within the comfort margin settings. For example, the user may be questioned as to whether or not a winter humidity compensation can be provided, whether or not a summer humidity compensation can be provided (i.e., the tolerance of higher or lower humidity), the willingness to have overnight energy savings due to the different rate schedules, or the fact that the user may be sleeping or the like, preferences on fan speeds, preferences with respect to maintenance schedules, as well as premium energy savings services which may be provided or accessible to the user. Of course, a number of other parameters may also be requested for additional savings. These may be identified as different savings settings.

Knowing this information, the system remains in an idle state, and looks to determine if the save button is depressed. The save button may be a button, or a slider that is provided on the remote controller. This occurs at 400. Once depressed, the different consumer preferences are reviewed at 410. It will be understood that these parameters may be requested a first time that the system is utilized, or may be requested or updated each time the save button is on or activated.

At 420, a determination is made as to which of the different parameters can be adjusted per the user, and also which are capable of being adjusted. Next, at 430 based on the different parameters that are available (and in the example, they are hierarchical, in that once a parameter is found that can be altered, the system moves to the alteration), the different possible adjustments are determined for each change in the setpoint temperature. Next, at 440, the system determines the actual adjustment to the setpont temperature to determine if the system will remain in the comfort margin. At 450, the system checks the schedule to determine impact on the upcoming schedule (i.e., if the schedule is to change to a non-save schedule, then a different adjustment may be contemplated). Finally, at 460, when the proper parameter to be adjusted is determined, the information is processed and the system begins to control the HVAC system to process the savings. At the same time, the savings can be determined and can be transmitted to the user.

Advantageously, the user can repeatedly hit the save button, and the system will again determine the next adjustment that can provide a savings proceeding through the different steps at 420. The same calculations are then completed in steps 430 through 450, and the chosen method of savings is implemented by the system at 460. Thus, every time the user hits the save button, a real savings can be realized, and calculations can be made to determine the level of savings. The level of savings can be provided back to the user through the controller.

Another system advantage is the control of the new schedules versus old schedules. In prior art systems, it is necessary to provide a program that is devoid of scheduling conflicts, or one that is complete. The system of the present disclosure avoids the foregoing by solving apparent conflicts in scheduling and by providing additional information where needed. This is accomplished instead of providing an error to the user, or requiring the user to enter a timing schedule that corresponds to the entire period of time of operation of the climate control system (i.e., a 24 hour period, or some subset thereof). Instead of an error message (based upon time overlap of programs, or programs with gaps in time), the system resolves a conflict internally, and accepts the new timing program.

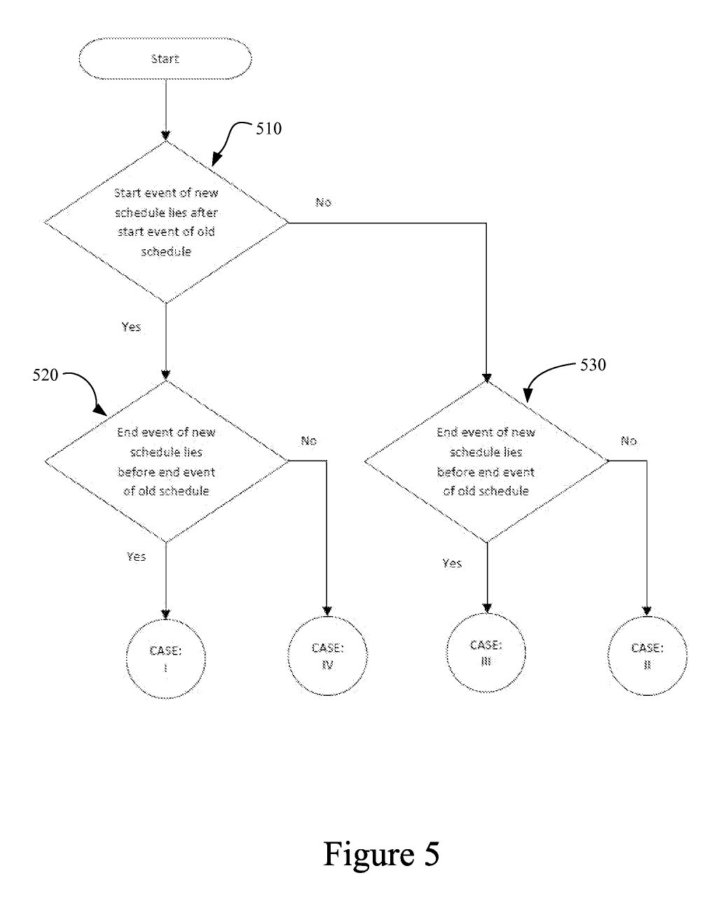

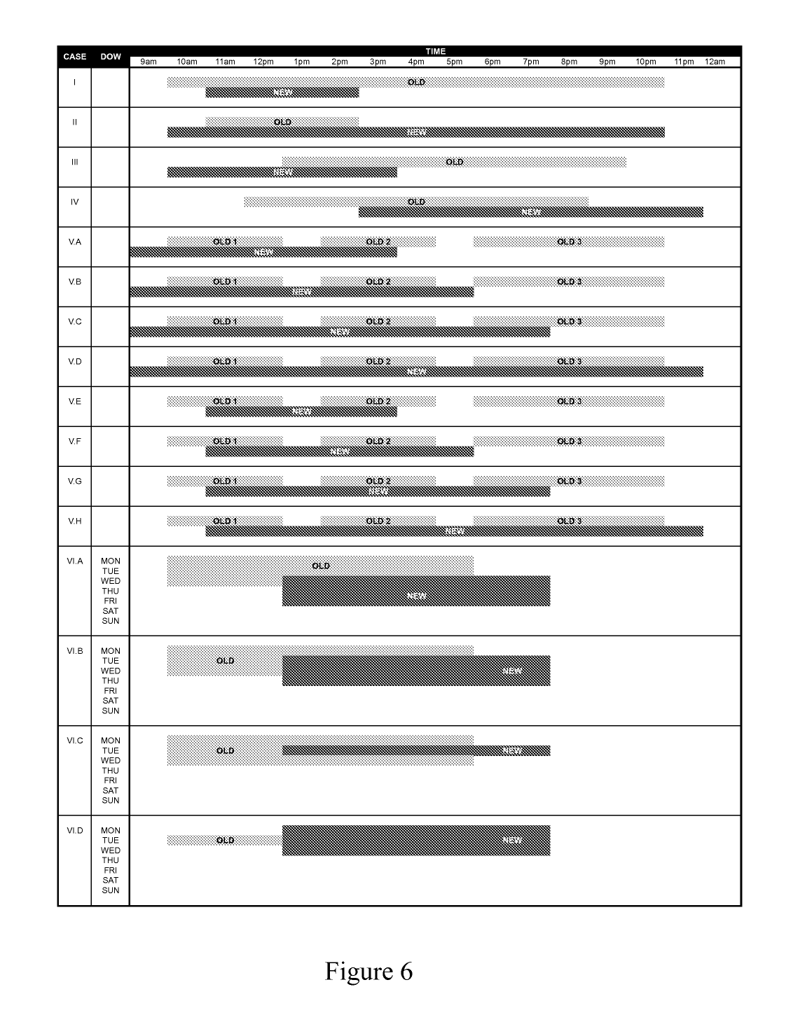

For example, the system is shown in the flow chart form in FIG. 5. At 510, the system reviews a newly added programming schedule, that includes a new start event and a new end event. The system determines if the start event of the new schedule lies after the start event of the old schedule. If this is the case, then the system proceeds to 520. At 520, the system determines if the end event of the new schedule lies before the end event of the old schedule. If this is the case, then we have the first type of conflict. The first case is shown in FIG. 6 as Case I. In this case, the old program is run for all times that are outside of the new program, and the new program runs during the new program times. Once the end event is reached with the new program, the system reverts back to the old program.

If, on the other hand, at 520, the system determines that the end event of the new schedule does not lie before the end event of the old schedule, then we have a different type of conflict. This conflict is shown graphically in FIG. 6 as case IV. In this case, the old program is run until the new program starts. The new program continues beyond the end of the old program. Thus, only the beginning of the old program is run.

In the event that at 510, the start event of the new schedule does not lie after the start event of the old schedule, the system proceeds to 530. At 530, the system determines as to whether the end event of the new schedule lies before the end event of the old schedule. If it does, then we have another type of conflict. This conflict is shown graphically in FIG. 6 as case III. In this case, the new program is run for its entire duration. At the completion of running the new program, the system reverts back to the old program.

On the other hand, if the end event of the new schedule does not lie before the end event of the old schedule, then we have another type of conflict. This conflict is shown graphically in FIG. 6 as case II. In this case, the old program is not run, and instead, the new program completely takes over and overlies the entire time of the old program.

These basic scenarios can be expanded to include the overlap of multiple old unrelated programs. However, the same principles apply. The new program is run in place of the old program for the time periods of overlap. For example, and with reference to FIG. 6, for Case V.A., the old 1 program is not run in favor of the new program. When the new program ends, the system reverts to the remaining portion of the old 2 program. The same principles can be seen through the other Cases represented by Cases V.B through V.H. Additionally, weekly schedules are shown in VI.A through VI.D. However, the principles and the flowchart analysis remains the same. That is, where there is overlap, the old system is run for time periods that are outside of the new time periods.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A thermostat comprising:
a first communication connection, the first communication connection in communication with at least one condition sensor;
a second communication connection, the second communication connection in communication with a climate control system;
a user communication connection, the user communication connection configured to receive an input from a user requesting a change in operating parameters of the thermostat;
one or more processor units in communication with the first and second communication connections and the user communication connection; and
one or more computer-readable media comprising computer-executable instructions which when executed by the one or more processing units cause the thermostat to perform steps comprising:
receiving a communication from the user communication connection to reduce a cost of operating the climate control system;
receiving communication through the first communication connection pertaining to the at least one condition sensor;
determining at least one operating parameter of the climate control system to be changed to reduce the cost of operating the climate control system; and
communicating through the second communication connection with the climate control system to alter the at least one operating parameter of the climate control system to achieve a reduction in the cost of operating the climate control system.

2. The thermostat of claim 1 wherein the one or more computer-readable media further includes computer-executable instructions which when executed by the one or more processing units cause the thermostat to perform steps comprising:
receiving through the user communication connection at least a lower and an upper threshold of the at least one operating parameter of the climate control system;
wherein the step of determining an operating parameter of the climate control system to be changed further includes the step of confirming that the at least one operating parameter to be changed results in the at least one operating parameter being between the lower and upper threshold of the operating parameter.

3. The thermostat of claim 2 wherein the at least one operating parameter comprises at least one of temperature and humidity.

4. The thermostat of claim 2 wherein the step of receiving further includes the receiving of a lower and an upper threshold of the at least one operating parameter pertaining to a comfort range, and a lower and an upper threshold of the at least one operating parameter pertaining to a comfort margin.

5. The thermostat of claim 2 wherein the at least one operating parameter includes a plurality of operating parameters, with each of the operating parameters including a comfort range and a comfort margin, wherein the step of determining an operating parameter of the climate control system to be changed further includes the step of determining which of the plurality of operating parameters is to be changed to maintain the user closer to or within the comfort range.

6. The thermostat of claim 2 wherein the thermostat further includes:
data pertaining to operating cost of the climate control system; and
wherein the one or more computer-readable media further includes computer-executable instructions which when executed by the one or more processing units cause the thermostat to perform steps comprising:
determining the change in operating cost of the climate control system based upon the change in the at least one operating parameter;
providing to the user the determined change in operating cost.

7. The thermostat of claim 1 wherein the user communication connection is configured to receive a single communication in the form of a request to save from a user.

8. A thermostat comprising:
a first communication connection, the first communication connection in communication with at least one condition sensor;
a second communication connection, the second communication connection in communication with a climate control system;
a user communication connection, the user communication connection configured to receive an input from a user as to a timing schedule for the operation of the climate control system;
one or more processor units in communication with the first and second communication connections and the user communication connection; and
one or more computer-readable media comprising computer-executable instructions which when executed by the one or more processing units cause the thermostat to perform steps comprising:
receiving a timing schedule from a user;
determining if the timing schedule from the user conflicts with an existing timing schedule; and
performing a conflict resolution to determine an operating timing schedule based on the timing schedule from the user and the existing timing schedule.

9. The thermostat of claim 8 wherein the step of performing a conflict resolution further includes the step of utilizing the new timing schedule in place of the existing timing schedule where an overlap exists, and utilizing the existing timing schedule before and after the new timing schedule.

10. The thermostat of claim 8 wherein the step of performing a conflict resolution to determine an operating timing schedule based upon the timing schedule from the user and the existing timing schedule further is achieved without further input from a user, or requiring a change in the timing schedule submitted by the user prior to operation.

11. A method of operating a thermostat comprising the steps of:
receiving a communication from a user communication connection to reduce a cost of operating a climate control system;
receiving communication through a first communication connection pertaining to the at least one condition sensor;
determining at least one operating parameter of the climate control system to be changed to reduce the cost of operating the climate control system; and
communicating through a second communication connection with the climate control system to alter the at least one operating parameter of the climate control system to achieve a reduction in the cost of operating the climate control system;
receiving a timing schedule from a user;
determining if the timing schedule from the user conflicts with an existing timing schedule; and
performing a conflict resolution to determine an operating timing schedule based on the timing schedule from the user and the existing timing schedule.

12. The method of claim 11 wherein the method of operating a thermostat further comprises the steps of:
receiving through the user communication connection at least a lower and an upper threshold of the at least one operating parameter of the climate control system;
wherein the step of determining an operating parameter of the climate control system to be changed further includes the step of confirming that the at least one operating parameter to be changed results in the at least one operating parameter being between the lower and upper threshold of the operating parameter.

13. The method of claim 12 wherein the at least one operating parameter comprises at least one of temperature and humidity.

14. The method of claim 12 wherein the step of receiving further includes the receiving of a lower and an upper threshold of the at least one operating parameter pertaining to a comfort range, and a lower and an upper threshold of the at least one operating parameter pertaining to a comfort margin.

15. The method of claim 12 wherein the at least one operating parameter includes a plurality of operating parameters, with each of the operating parameters includes a comfort range and a comfort margin, wherein the step of determining an operating parameter of the climate control system to be changed further includes the step of determining which of the plurality of operating parameters to be changed to maintain the user closer to or within the comfort range.

16. The method of claim 12 wherein the thermostat further includes data pertaining to operating cost of the climate control system, the method further comprising the steps of:
determining the change in operating cost of the climate control system based upon the change in the at least one operating parameter;
providing to the user the determined change in operating cost.

17. The method of claim 11 wherein the thermostat is configured to receive a single communication in the form of a request to save from a user.

18. The method of claim 11 wherein the step of performing a conflict resolution further includes the step of utilizing the new timing schedule in place of the existing timing schedule where an overlap exists, and utilizing the existing timing schedule before and after the new timing schedule.

19. The method of claim 11 wherein the step of performing a conflict resolution to determine an operating timing schedule based upon the timing schedule from the user and the existing timing schedule further is achieved without further input from a user, or requiring a change in the timing schedule submitted by the user prior to operation.
